(19) United States
(12) Patent Application Publication
(10) Pub. No.: US 2020/0033197 A1
(43) Pub. Date: Jan. 30, 2020

(54) PROCESSING APPARATUS

(71) Applicant: Mitsubishi Electric Corporation, Chiyoda-ku (JP)

(72) Inventor: Shuta TAMANO, Tokyo (JP)

(73) Assignee: Mitsubishi Electric Corporation, Chiyoda-ku (JP)

(21) Appl. No.: 16/076,858

(22) PCT Filed: Jul. 11, 2017
(86) PCT No.: PCT/JP2017/025317

§ 371 Date: Aug. 9, 2018

(51) Int. Cl. G01K 7/02; G01K 15/00

(52) U.S. Cl. CPC G01K 7/021; G01K 15/00

(57) ABSTRACT

A processing apparatus has an analog circuit therein and includes an installation orientation detector that detects a position of installation of the processing apparatus, an energization time measurement timer that measures an energization time during which the processing apparatus is energized, and a processor that corrects a result of processing in the analog circuit on the basis of a result of detection by the installation orientation detector and a result of measurement by the energization time measurement timer. The processing apparatus can thus reduce a stable operation standby time of the analog circuit.

### FIELD

The present invention relates to a processing apparatus that can correct a fluctuation in a result of processing of an analog circuit.

### BACKGROUND

A device such as a wireless device or a remote unit which is a controller of an industrial distributed control system may be installed in various orientations and angles due to the characteristics of the device. Patent Literature 1 discloses a device in which a circuit requiring temperature compensation and a heat generating unit generating a large amount of heat are disposed in a casing. The device disclosed in Patent Literature 1 does not include a function of forcibly circulating the air inside the device. As a result, heat convection inside the device changes depending on the position of the device and thus affects a distribution of the internal temperature of the device and a change in the internal temperature of the device. For this reason, the device of Patent Literature 1 acquires information on the installation angle of the device from a tilt sensor and measures an expected temperature in the circuit requiring temperature compensation on the basis of information in a correction table corresponding to the installation angle and temperature information acquired from a temperature sensor.

The accuracy of processing in the analog circuit represented by a temperature measurement circuit may be affected by a change in electrical characteristics due to temperature. Thus, in order to satisfy product specifications, many devices including the analog circuit set a standby time before the electrical characteristics of the analog circuit are stabilized with heat generation of electronic components in the device being saturated, or a stable operation standby time before the analog circuit operates properly. The device setting the stable operation standby time for the analog circuit does not guarantee the accuracy of the established product specifications until the stable operation standby time elapses. That is, the device should be entirely idling until the stable operation standby time elapses, thus wait from start-up of the device to the start of operation.

### CITATION LIST

### Patent Literature

Patent Literature 1: Japanese Patent Application Laid-open No. 2012-233835

### SUMMARY

### Technical Problem

The technique of Patent Literature 1 described above cannot reduce the stable operation standby time of the analog circuit and thus should wait for minutes from start-up of the device to the start of operation.

The present invention has been made in view of the above, and an object of the invention is to obtain a processing apparatus that includes an analog circuit and can reduce a stable operation standby time of the analog circuit.

### Solution to Problem

To solve the problem and achieve the object, the present invention provides a processing apparatus having an analog circuit therein, the processing apparatus comprising: an installation orientation detection unit to detect a position of installation of the processing apparatus; an energization time measurement unit to measure an energization time during which the processing apparatus is energized; and a control unit to correct a result of processing in the analog circuit on the basis of a result of detection by the installation orientation detection unit and a result of measurement by the energization time measurement unit.

### Advantageous Effects of Invention

The processing apparatus according to the present invention includes the analog circuit and can reduce the stable operation standby time of the analog circuit.

### BRIEF DESCRIPTION OF DRAWINGS

FIG. 1 is a diagram illustrating the configuration of a temperature measurement system including a processing apparatus according to a first embodiment of the present invention.

FIG. 2 is a diagram illustrating an example of the hardware configuration of a processing circuit according to the first embodiment of the present invention.

FIG. 3 is a flowchart describing a procedure of a method of measuring a temperature of a measurement target by the processing apparatus according to the first embodiment of the present invention.

FIG. 4 is a schematic diagram illustrating an example of the installation orientation of the processing apparatus according to the first embodiment of the present invention.

FIG. 5 is a schematic diagram illustrating an example of the installation orientation of the processing apparatus according to the first embodiment of the present invention.

FIG. 6 is a schematic diagram illustrating an example of the installation orientation of the processing apparatus according to the first embodiment of the present invention.

FIG. 7 is a schematic diagram illustrating an example of the installation orientation of the processing apparatus according to the first embodiment of the present invention.

FIG. 8 is a schematic diagram illustrating an example of the installation orientation of the processing apparatus according to the first embodiment of the present invention.

FIG. 9 is a schematic diagram illustrating an example of the installation orientation of the processing apparatus according to the first embodiment of the present invention.

FIG. 10 is a table illustrating an example of a correction expression table stored in a storage unit of the processing apparatus according to the first embodiment of the present invention.

FIG. 11 is a characteristic diagram illustrating an example of a relationship between an input voltage input to a thermocouple input unit and an A/D converted value resulting from A/D conversion by an A/D conversion unit, the input voltage and the A/D converted value being measured under conditions of a certain installation orientation and a certain ambient temperature by the processing apparatus according to the first embodiment of the present invention.

FIG. 12 is a characteristic diagram illustrating an example of a relationship between measured values of an energization time and an A/D converted value, the values being measured under conditions of a certain installation orientation, a certain ambient temperature, and a certain thermocouple voltage by the processing apparatus according to the first embodiment of the present invention.

FIG. 13 is a diagram illustrating the configuration of a temperature measurement system including a processing apparatus according to a second embodiment of the present invention.

FIG. 14 is a flowchart describing a procedure of a method of measuring a temperature of a measurement target by the processing apparatus according to the second embodiment of the present invention.

### DESCRIPTION OF EMBODIMENTS

A processing apparatus according to embodiments of the present invention will now be described in detail with reference to the drawings. Note that the present invention is not limited to the embodiments.

### First Embodiment

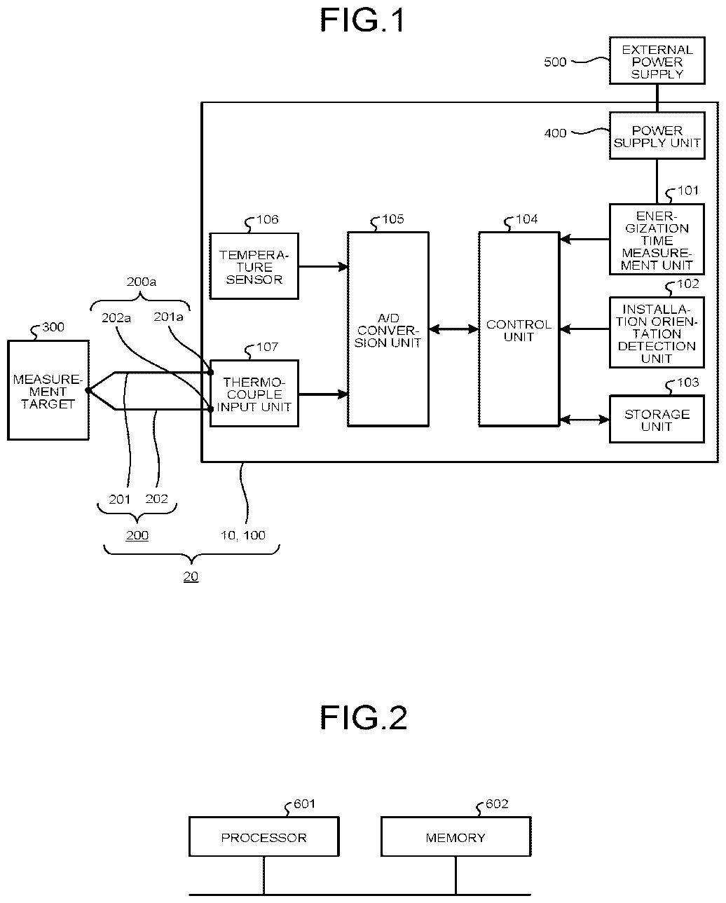

A first embodiment describes a case where a temperature measurement system 20 including a processing apparatus 100 according to the first embodiment measures the temperature of a temperature measurement target. FIG. 1 is a diagram illustrating the configuration of the temperature measurement system 20 including the processing apparatus 100 according to the first embodiment of the present invention.

The temperature measurement system 20 includes a thermocouple 200 that detects the temperature of a measurement target 300 which is an arbitrary temperature measurement target subjected to temperature measurement, and the processing apparatus 100 that calculates the temperature of the measurement target 300 by correcting the value thermoelectrically converted and detected by the thermocouple 200. The processing apparatus 100 and the thermocouple 200 above define the temperature measurement system 20 according to the first embodiment. Note that the processing apparatus 100 can be configured as a wireless device 10 which is a remote unit having a wireless communication function. The wireless device 10 has a plurality of circuits implementing the wireless communication function, but the description thereof will be omitted. Thus, in this case, the wireless device 10 and the processing apparatus 100 can be thought of as being functionally identical.

The processing apparatus 100 includes an energization time measurement unit 101 that measures time of energization from an external power supply 500 to the processing apparatus 100, and an installation orientation detection unit 102 that detects the installation orientation in which the processing apparatus 100 is installed. The installation orientation is a piece of information indicating the position of the processing apparatus 100, i.e, indicating which orientation the processing apparatus 100 is installed in. The processing apparatus 100 further includes a control unit 104 and a storage unit 103. The control unit 104 corrects a digital value corresponding to the input temperature of the measurement target 300 and subjects the corrected digital value to cold junction compensation, thereby calculating the temperature of the measurement target 300. The storage unit 103 stores a correction expression table storing a correction expression used when the control unit 104 corrects the digital value corresponding to the temperature of the measurement target 300. The processing apparatus 100 further includes an analog-to-digital (A/D) conversion unit 105, a temperature sensor 106, a thermocouple input unit 107, and a power supply unit 400. The analog-to-digital (A/D) conversion unit 105 converts an input analog value into a digital value. The temperature sensor 106 measures the ambient temperature of the processing apparatus 100. The thermocouple input unit 107 receives input of a voltage signal of thermoelectromotive force which is thermoelectrically converted by the thermocouple 200. The power supply unit 400 supplies power to each unit in the processing apparatus 100.

The energization time measurement unit 101 measures and transmits, to the control unit 104, the energization time during which the external power supply 500 energizes the processing apparatus 100 with the processing apparatus 100 being turned on. The energization time measurement unit 101 may transmit the energization time when requested by the control unit 104 to transmit the energization time. In the processing apparatus 100, power is supplied from the external power supply 500 to the power supply unit 400, which in turn supplies the power to each unit in the processing apparatus 100.

The energization time measurement unit 101 can be configured by a combination of a voltmeter for detecting energization to the processing apparatus 100 and a timer capable of measuring the time during which the voltmeter detects the energization to the processing apparatus 100. Alternatively, the energization time measurement unit 101 may be a commonly used timer for measuring the energization time. The timer is provided by a timer device or a timer function built in a microcomputer. In the first embodiment, the timer for measuring the energization time measuring timer is used as the energization time measurement unit 101.

The installation orientation detection unit 102 is activated under control of the control unit 104, detects the installation orientation of the processing apparatus 100 at a predetermined cycle, and transmits the detected installation orientation to the control unit 104. The installation orientation detection unit 102 may transmit the installation orientation when requested by the control unit 104 to transmit the installation orientation. A sensor capable of detecting the installation orientation of the processing apparatus 100 is used as the installation orientation detection unit 102. The sensor useable as the installation orientation detection unit 102 includes an acceleration sensor, a gyro sensor, and a tilt sensor.

The storage unit 103 stores the correction expression table storing the correction expressions obtained from measured values measured in advance. A non-volatile memory such as a flash memory or an electrically erasable programmable read-only memory (EEPROM) (registered trademark) is used as the storage unit 103.

The thermocouple input unit 107 provides a result of processing, which in turn is converted into an A/D converted value by A/D conversion. The control unit 104 corrects the A/D converted value on the basis of a result of measurement by the energization time measurement unit 101 and a result of detection by the installation orientation detection unit 102. The result of processing provided by the thermocouple input unit 107 is a thermocouple voltage detected by the thermocouple input unit 107. The detected thermocouple voltage indicates the thermoelectromotive force which is a voltage generated between two metal wires 201 and 202 of the thermocouple 200. On the basis of information on the installation orientation of the processing apparatus 100 and information on the ambient temperature of the processing apparatus 100, the control unit 104 selects an appropriate correction expression from the correction expression table stored in the storage unit 103. The control unit 104 then uses the selected correction expression to correct an A/D converted value ad transmitted from the thermocouple input unit 107 via the A/D conversion unit 105 to the control unit 104. The A/D converted value ad is a result of A/D conversion of the detected thermocouple voltage by the A/D conversion unit 105. The A/D converted value ad is a digital value corresponding to the temperature of the measurement target 300.

The control unit 104 also performs cold junction compensation on the A/D converted value ad. More specifically, a cold junction compensation temperature detected by the temperature sensor 106 is converted into a voltage, which is in turn converted by A/D conversion in the A/D conversion unit 105 into a value. The control unit 104 uses this value to perform the cold junction compensation on the A/D converted value ad.

The control unit 104 further performs overall control on the processing apparatus 100. When the power supply of the processing apparatus 100 is turned on, the control unit 104 performs control to activate the energization time measurement unit 101, the installation orientation detection unit 102, the temperature sensor 106, and the thermocouple input unit 107.

The control unit 104 is implemented as a processing circuit having the hardware configuration illustrated in FIG. 2, for example. FIG. 2 is a diagram illustrating an example of the hardware configuration of the processing circuit according to the first embodiment of the present invention. The control unit 104 is implemented as the processing circuit with the hardware configuration illustrated in FIG. 2 when a processor 601 illustrated in FIG. 2 executes a program stored in a memory 602, for example. Alternatively, a plurality of processors and a plurality of memories may cooperatively implement the functions of the control unit 104. Yet alternatively, some of the functions of the control unit 104 may be implemented as an electronic circuit, and the other functions may be implemented by using the processor 601 and the memory 602. Moreover, the storage unit 103 can be implemented using the memory 602.

The A/D conversion unit 105 converts into a digital value the detected thermocouple voltage which is the measured temperature value of the measurement target 300 detected by the thermocouple input unit 107; then, the A/D conversion unit 105 transmits the digital value to the control unit 104. The A/D conversion unit 105 further converts into a digital value a measured temperature value which is a voltage value converted from the ambient temperature of the processing apparatus 100, the voltage value being input from the temperature sensor 106; then, the A/D conversion unit 105 transmits the digital value to the control unit 104.

The temperature sensor 106 is configured using an element such as a thermistor or a resistance temperature detector whose electrical resistance varies depending on the temperature. At least one temperature sensor 106 is provided in the processing apparatus 100 to measure the ambient temperature of the processing apparatus 100 in a predetermined cycle, convert the measured temperature into the voltage value, and transmit the voltage value to the A/D conversion unit 105. The temperature sensor 106 detects the ambient temperature of the processing apparatus 100 and the temperature of a terminal 200a of the thermocouple input unit 107 connected to the thermocouple 200, namely, the temperatures of a terminal 201a and a terminal 202a. The detected ambient temperature and the detected temperatures of the terminals are used as correction temperatures used when the control unit 104 corrects and calculates the temperature of the temperature measurement target. The temperature sensor 106 converts the measured temperatures into the voltage values and transmitting the voltage values to the A/D conversion unit 105. That is, the temperature sensor 106 serves not only as a temperature sensor to detect the temperature of the terminal 200a for the purpose of cold junction compensation, that is, a temperature sensor to compensate for the thermoelectromotive force obtained by the thermocouple 200, but also as a temperature sensor to obtain the ambient temperature of the processing apparatus 100. The cold junction compensation temperature is used as the same temperature as the ambient temperature of the processing apparatus 100. The presence of this temperature sensor 106 can reduces the number of temperature sensors and thus achieve the cost reduction. The value detected by the temperature sensor is an analog value.

Whether the temperature sensor 106 can serve not only as the temperature sensor for obtaining the ambient temperature, but also the temperature sensor for detecting the temperatures of the terminals 201a and 202a for the purpose of cold junction compensation needs to be determined taking account of conditions such as the accuracy of a correlation between the ambient temperature of the processing apparatus 100 and the temperature of the terminal 200a, that is, the accuracy of sameness of these temperatures, and the A/D conversion speed of the A/D conversion unit 105. The temperature sensor for obtaining the ambient temperature and the temperature sensor for detecting the temperature of the terminal 200a for the purpose of cold junction compensation may be provided separately.

In order to detect the ambient temperature of the processing apparatus 100 accurately, the temperature sensors 106 has its position and number determined in consideration of conditions such as the shape of the processing apparatus 100, the configuration of a substrate disposed in the processing apparatus 100, and the arrangement of a circuit disposed in the processing apparatus 100. Note that when a plurality of the temperature sensors 106 is disposed, the control unit 104 uses an average value of detected values acquired from the plurality of temperature sensors 106.

The thermocouple input unit 107 is an analog circuit provided in the device to detect the thermoelectromotive force subjected to thermoelectric conversion by the thermocouple 200, in a predetermined cycle and transmit the detected voltage value to the A/D conversion unit 105.

The thermocouple 200 includes the two metal wires 201 and 202. One end of the metal wire 201 and one end of the metal wire 202 are connected to each other while an opposite end of the metal wire 201 and an opposite end of the metal wire 202 are connected to the terminal 201a of the thermocouple input unit 107 and the terminal 202a of the thermocouple input unit 107, respectively. The thermoelectromotive force subjected to thermoelectric conversion by the thermocouple 200 is a voltage between the terminal 201a and the terminal 202a.

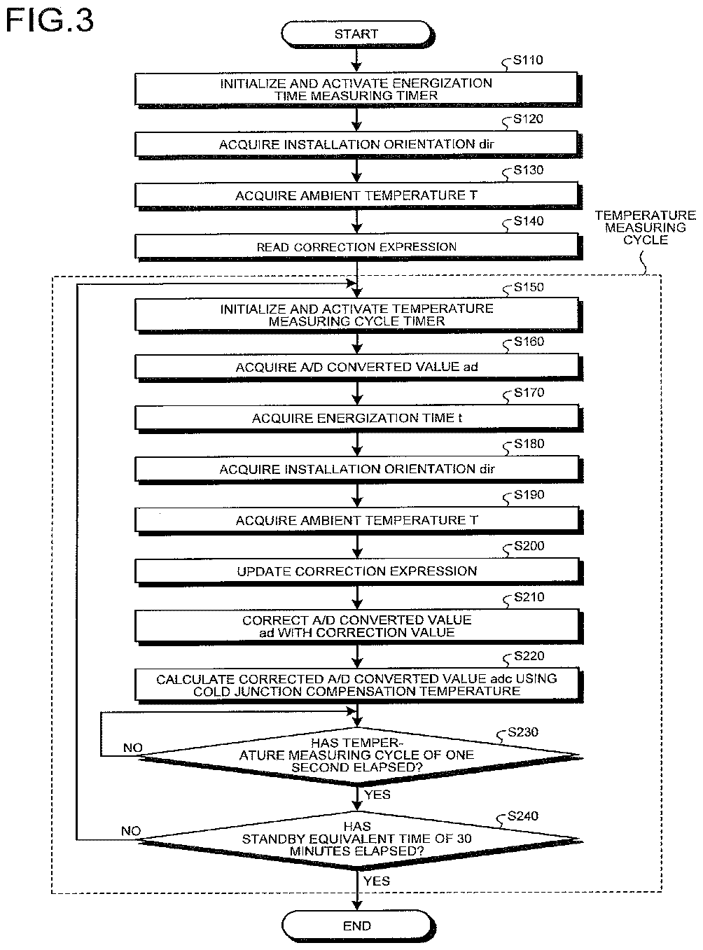

Next, a method of measuring the temperature of the measurement target 300 by the temperature measurement system 20 will be described. FIG. 3 is a flowchart describing a procedure of the method of measuring the temperature of the measurement target 300 by the processing apparatus 100 according to the first embodiment of the present invention. Without the processing apparatus 100 of the present embodiment, an error would occur in the temperature value of the measurement target 300 measured by the thermocouple input unit 107 before a lapse of time equivalent to a stable operation standby time of the thermocouple input unit 107. According to the procedure of FIG. 3, such an error is corrected to thereby calculate the temperature of the measurement target 300. The stable operation standby time of the thermocouple input unit 107 is a standby time taken before the stabilization of temperature-influenced electrical characteristics of the thermocouple input unit 107 that is the analog circuit. That is, the stable operation standby time is a standby time taken before the thermocouple input unit 107 operates properly. Hereinafter, the time equivalent to the stable operation standby time of the thermocouple input unit 107 may be referred to as a standby equivalent time for convenience.

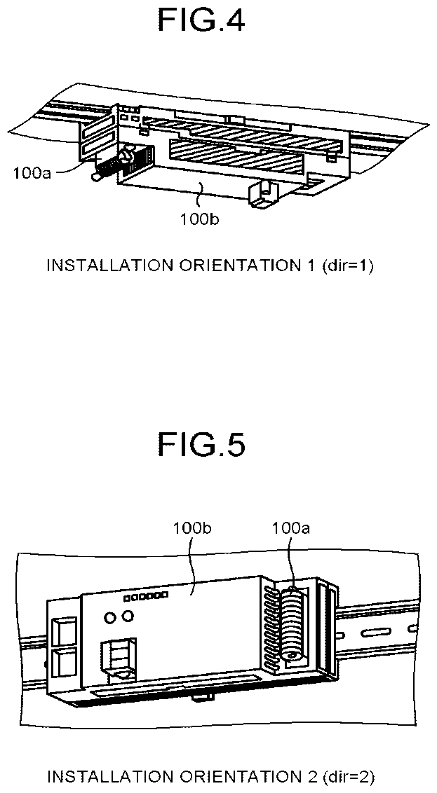

FIGS. 4 to 9 are schematic diagrams each illustrating an example of the installation orientation of the processing apparatus 100 according to the first embodiment of the present invention. Moreover, when correcting the error in the measured temperature value of the measurement target 300 detected by the thermocouple input unit 107, the processing apparatus 100 acquires information including installation orientation dir of the processing apparatus 100, ambient temperature T of the processing apparatus 100, an energization time t of the processing apparatus 100, and the A/D converted value ad.

First in step S110, the control unit 104 initializes the energization time measuring timer of the energization time measurement unit 101 to set a count value to zero, and activates the energization time measuring timer to start measuring the energization time of the processing apparatus 100. The following description is based on the assumption that the energization time measuring timer updates the time in increments of the minute and the standby equivalent time is set to 30 minutes.

Next in step S120, the control unit 104 reads and acquires, from the installation orientation detection unit 102, a corresponding index corresponding to the installation orientation of the processing apparatus 100 defined as illustrated in FIGS. 4 to 9. In the first embodiment, the installation orientation dir of the processing apparatus 100 is defined as “installation orientation 1” when the processing apparatus 100 is installed with a reference position 100a of the processing apparatus 100 disposed on the left side and an upper surface 100b of the processing apparatus 100 facing downward as illustrated in FIG. 4. The installation orientation dir which is the corresponding index corresponding to installation orientation 1 is set to “1”.

The installation orientation dir of the processing apparatus 100 is defined as “installation orientation 2” when the processing apparatus 100 is installed in a position where the reference position 100a of the processing apparatus 100 is disposed on the right side and the upper surface 100b of the processing apparatus 100 faces frontward, as illustrated in FIG. 5. The installation orientation dir which is the corresponding index corresponding to installation orientation 2 is set to “2”.

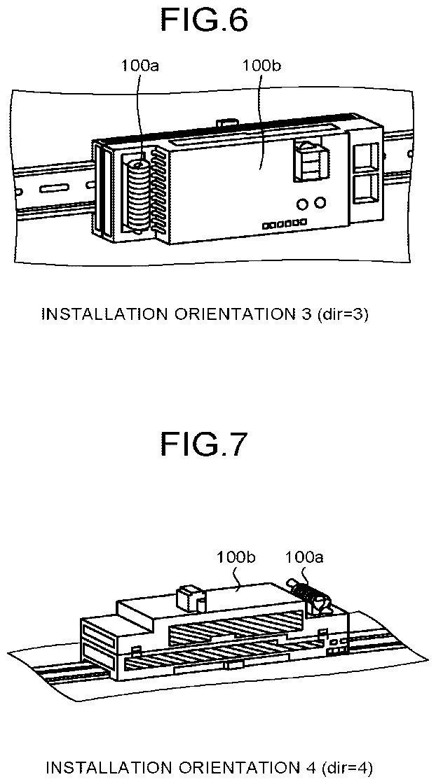

The installation orientation dir of the processing apparatus 100 is defined as “installation orientation 3” when the processing apparatus 100 is installed in a position where the reference position 100a of the processing apparatus 100 is disposed on the left side and the upper surface 100b of the processing apparatus 100 faces frontward, as illustrated in FIG. 6. The installation orientation dir which is the corresponding index corresponding to installation orientation 3 is set to “3”.

The installation orientation dir of the processing apparatus 100 is defined as “installation orientation 4” when the processing apparatus 100 is installed in a position where the reference position 100a of the processing apparatus 100 is disposed on the right side and the upper surface 100b of the processing apparatus 100 faces upward, as illustrated in FIG. 7. The installation orientation dir which is the corresponding index corresponding to installation orientation 4 is set to “4”.

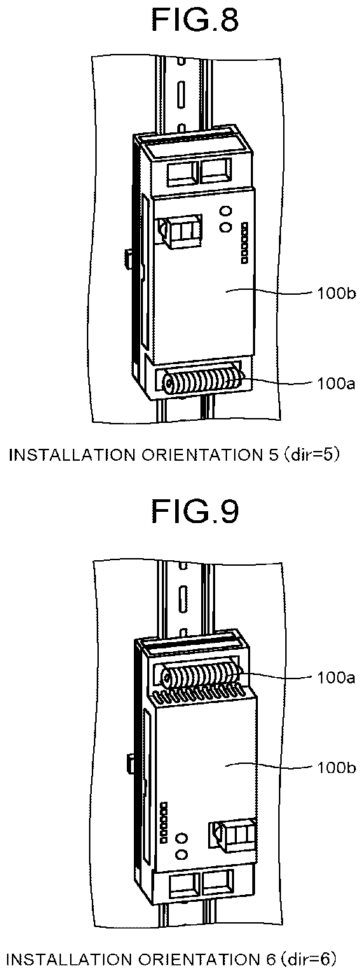

The installation orientation dir of the processing apparatus 100 is defined as “installation orientation 5” when the processing apparatus 100 is installed in a position where the reference position 100a of the processing apparatus 100 is disposed on the lower side and the upper surface 100b of the processing apparatus 100 faces frontward, as illustrated in FIG. 8. The installation orientation dir which is the corresponding index corresponding to installation orientation 5 is set to “5”.

The installation orientation dir of the processing apparatus 100 is defined as “installation orientation 6” when the processing apparatus 100 is installed in a position where the reference position 100a of the processing apparatus 100 is disposed on the upper side and the upper surface 100b of the processing apparatus 100 faces frontward, as illustrated in FIG. 9. The installation orientation dir which is the corresponding index corresponding to installation orientation 6 is set to “6”.

Next in step S130, the control unit 104 acquires the ambient temperature T, which is a corresponding index corresponding to the ambient temperature of the processing apparatus 100 acquired by the temperature sensor 106. The ambient temperature of the processing apparatus 100 is measured by the temperature sensor 106, converted into a voltage value indicating the measured temperature, and transmitted to the A/D conversion unit 105. The A/D conversion unit 105 converts the voltage value received from the temperature sensor 106 into a digital value that is an A/D converted value D104; then, the A/D conversion unit 105 transmits the A/D converted value D104 to the control unit 104.

On the basis of the A/D converted value D104, the control unit 104 acquires the ambient temperature T, which is the corresponding index corresponding to the ambient temperature of the processing apparatus 100. The temperature sensor 106 converts the ambient temperature of the processing apparatus 100 into the voltage value, and transmits the voltage value to the A/D conversion unit 105; then, the A/D conversion unit 105 subjects the voltage value to the A/D conversion to thereby provide the A/D converted value D104. This A/D converted value is received by the control unit 104. The control unit 104 holds in advance relationship information indicating the relationship between the A/D converted value D104 and the ambient temperature T. The ambient temperature T is assigned in correspondence to each of the three ambient temperatures of the processing apparatus 100, which are, for example, 0° C., 25° C., and 55° C.

The thermocouple 200 detects the thermocouple voltage exhibiting thermoelectromotive force characteristic in the form of a liner curve. When the thermocouple voltage detected by the thermocouple 200 has an analog value of 0 mV to 40 mV with respect to 0° C. to 100° C., for example, a digital value of 0 to 16000 corresponds to the analog value of 0 mV to 40 mV subjected to A/D conversion by the A/D conversion unit 105. When the ambient temperature of the processing apparatus 100 is “0° C.”, the A/D converted value D104 is “0” and the ambient temperature T, which is the corresponding index, is “0”. When the ambient temperature of the processing apparatus 100 is “25° C.”, the A/D converted value D104 is “4000” and the ambient temperature T, which is the corresponding index, is “1”. When the ambient temperature of the processing apparatus 100 is “55° C.”, the A/D converted value D104 is “8800” and the ambient temperature T, which is the corresponding index, is “2”.

Since, from the above relationship information, the control unit 104 selects the ambient temperature T corresponding to the A/D converted value D104 received from the A/D conversion unit 105, the control unit 104 acquires the ambient temperature T that is the corresponding index corresponding to the ambient temperature of the processing apparatus 100. Note that the A/D converted value D104 received from the A/D conversion unit 105 does not necessarily agree with that in the relationship information. If this is the case, the ambient temperature T corresponding to the A/D converted value close to the A/D converted value D104 received from the A/D conversion unit 105 is selected from among the A/D converted values D104 held in the relationship information.

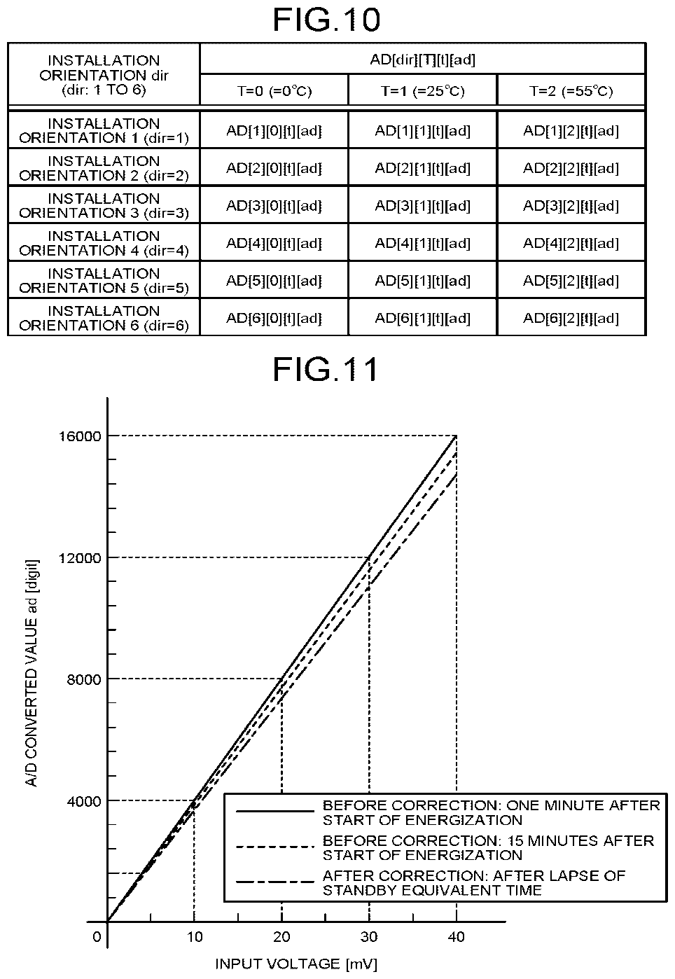

Next in step S140, the control unit 104 reads a correction expression from the correction expression table stored in the storage unit 103. FIG. 10 is a table illustrating an example of the correction expression table stored in the storage unit 103 of the processing apparatus 100 according to the first embodiment of the present invention. As illustrated in FIG. 10, the correction expression table classifies the installation orientation dir and the ambient temperature T, which are used as parameters. The correction expression table illustrated in FIG. 10 classifies the ambient temperature of the processing apparatus 100 into three temperatures: 0° C.; 25° C.; and 55° C. The control unit 104 refers to the installation orientation dir and the ambient temperature T acquired in steps S120 and S130 and reads an appropriate correction expression from the correction expression table.

The correction expression table assigns a correction expression AD [dir] [T] [t] [ad] corresponding to each of the conditions “0” to “2” of the ambient temperature T for the corresponding one of the conditions “1” to “6” of the installation orientation dir. The correction expression AD [dir] [T] [t] [ad] as used herein is a function of the installation orientation dir, the ambient temperature T, the energization time t, and the A/D converted value ad. A correction value can be calculated by substituting a numerical value into each of “[dir]”, “[T]”, “[t]”, and “[ad]” of the correction expression AD [dir] [T] [t] [ad].

The correction value is calculated in consideration of the installation orientation of the processing apparatus 100, so that even when a temperature distribution inside the device is changed by a change in the installation orientation or the installation angle of the device during the energization, the change in the temperature distribution can be reflected in the correction value. The correction value is calculated in consideration of the ambient temperature of the processing apparatus 100, so that even when the temperature inside the device changes during the energization, the change in the temperature inside the device can be reflected in the correction value.

The correction value is calculated in consideration of the energization time, so that a change in the temperature inside the device due to the energization can be reflected in the correction value. The correction value is calculated in consideration of the A/D converted value ad, so that the magnitude of an error in the A/D converted value ad resulting from the magnitude of the A/D converted value ad can be reflected in the correction value.

The correction expression AD [dir] [T] [t] [ad] is prepared in advance on the basis of values measured under conditions corresponding to the installation orientation dir and the ambient temperature T described above, and is stored in the memory of the control unit 104 or the storage unit 103.

FIG. 11 is a characteristic diagram illustrating an example of a relationship between an input voltage input to the thermocouple input unit 107 and the A/D converted value ad resulting from the A/D conversion by the A/D conversion unit 105, the input voltage and the A/D converted value being measured under conditions of a certain installation orientation and a certain ambient temperature by the processing apparatus 100 according to the first embodiment of the present invention. The input voltage is a voltage generated across the thermocouple 200 and detected by a voltage signal of the thermoelectromotive force generated by the thermocouple 200. FIG. 11 illustrates the relationship between the input voltage and the A/D converted value ad after: a lapse of one minute since the start of energization; a lapse of 15 minutes since the start of energization; and a lapse of time corresponding to the stable operation standby time of the thermocouple input unit 107.

FIG. 11 demonstrates that the measured values after the lapse of one minute since the energization and after the lapse of 15 minutes since the energization have errors with respect to the measured values in a stable state after the lapse of time corresponding to the stable operation standby time of the thermocouple input unit 107. This means that these errors occur in the A/D converted values resulting from the A/D conversion of the detected input voltage from the thermocouple input unit 107, until the standby equivalent time elapses even if the input voltage is actually the same. This is because the electrical characteristics of the thermocouple input unit 107, which is the analog circuit, change with temperature. The correction expressions stored in the correction expression table are prepared in order to correct the errors on the basis of the measured values illustrated in FIG. 11 as an example.

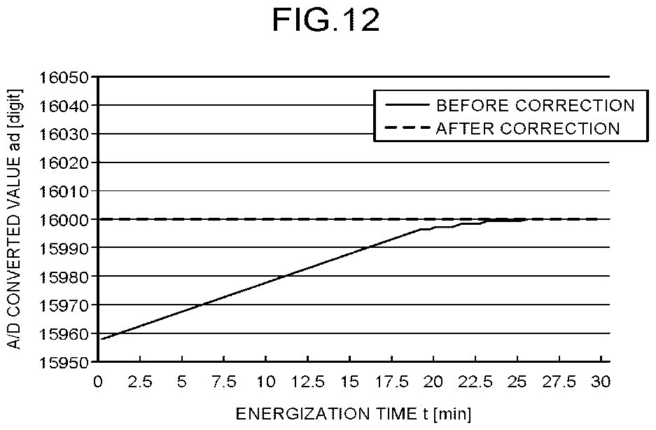

FIG. 12 is a characteristic diagram illustrating an example of a relationship between measured values of the energization time t and the A/D converted value ad, the values being measured under conditions of a certain installation orientation dir, a certain ambient temperature T, and a certain thermocouple voltage in the processing apparatus 100 according to the first embodiment of the present invention. FIG. 12 illustrates the relationship from the start of energization until after the lapse of the standby equivalent time. The values of the energization time and the A/D converted value ad illustrated in FIG. 12 are measured in order to create the correction expression table stored in the storage unit 103.

FIG. 12 demonstrates that when the A/D converted value ad is not corrected, an error occurs with respect to the measured value that is measured in the stable state after the lapse of the standby equivalent time. This means that this error occurs in the A/D converted value ad resulting from the A/D conversion of the detected voltage from the thermocouple input unit 107, until the standby equivalent time elapses even if the thermocouple voltage is actually the same. This is because the electrical characteristics of the thermocouple input unit 107, which is the analog circuit, change with temperature. Since the error is corrected in the first embodiment, the temperature of the measurement target 300, which is the temperature measurement target connected to the thermocouple 200, can be measured with high accuracy even before the standby equivalent time elapses, as in the measurement of the temperature of the measurement target 300 after the lapse of the standby equivalent time.

Note that the installation orientation dir and the ambient temperature T acquired by the control unit 104 in steps S120 and S130 do not necessarily agree with those in the correction expressions stored in the correction expression table. In this case, the control unit 104 can use, as the correction value, a value obtained by correcting a correction value that can be acquired from the correction expression table.

In the case where the installation orientation dir acquired is installation orientation 1 and the ambient temperature acquired is 30° C., the control unit 104 can refer to the measurement result and obtain the correction value by an interpolation between the correction value when the installation orientation dir is installation orientation 1 and the ambient temperature is 25° C., and the correction value when the installation orientation dir is installation orientation 1 and the ambient temperature is 55° C. Alternatively, the control unit 104 may use the correction value in the case of 25° C., which is the temperature closer to the acquired ambient temperature of 30° C.

Next in step S150, the control unit 104 initializes and activates a temperature measuring cycle timer.

In step S160, the control unit 104 acquires the A/D converted value ad from the A/D conversion unit 105.

In step S170, the control unit 104 reads and acquires the energization time t from the energization time measurement unit 101.

In step S180, the control unit 104 reads and acquires the installation orientation dir from the installation orientation detection unit 102.

In step S190, the control unit 104 reads and acquires the ambient temperature from the temperature sensor 106. That is, the control unit 104 reads and acquires the A/D converted value D104 from the A/D conversion unit 105. The control unit 104 then acquires the ambient temperature T on the basis of the A/D converted value D104 and the relationship information stored in advance and indicating the relationship between the A/D converted value D104 and the ambient temperature T.

Next in step S200, on the basis of the installation orientation dir and the ambient temperature T acquired in steps S180 and S190, the control unit 104 reads an appropriate correction expression from the correction expression table stored in the storage unit 103, thereby updating the correction expression read in step S140. Note that the correction expression need not be updated when the correction expression read in step S140 is an appropriate correction expression for the installation orientation dir and the ambient temperature T acquired in steps S180 and S190.

In step S210, the control unit 104 substitutes into the correction expression the A/D converted value ad, the energization time t, the installation orientation dir, and the ambient temperature T read in steps S160 to S190, and calculates a correction value. The control unit 104 then corrects the A/D converted value ad by adding the calculated correction value to the A/D converted value ad acquired in step S160.

In step S220, the control unit 104 acquires from the temperature sensor 106 the cold junction compensation temperature of the terminal 200a for cold junction compensation. That is, the control 104 acquires the temperature of the terminal 200a from the temperature sensor 106. Since the temperature sensor 106 of the first embodiment serves both as the temperature sensor of the terminal 200a for cold junction compensation and as the temperature sensor for obtaining the ambient temperature of the processing apparatus 100, the cold junction compensation temperature and the ambient temperature of the processing apparatus 100 are the same. The control unit 104 can thus use the A/D converted value D104 acquired in step S190, as the cold junction compensation temperature. Accordingly, the control unit 104 calculates a corrected A/D converted value adc by further adding the A/D converted value D104 to the A/D converted value ad corrected in step S210. As a result, a digital value corresponding to the temperature of the measurement target 300, which is the temperature measurement target, is acquired. This digital value may be used as it is by another functional unit (not illustrated) in the processing apparatus 100, or may be converted into temperature as needed.

In the case where the temperature sensor for the terminal 200a for the purpose of cold junction compensation and the temperature sensor for obtaining the ambient temperature of the processing apparatus 100 are provided separately, the cold junction compensation temperature of the terminal 200a detected by the temperature sensor for cold junction compensation is converted into a voltage value, which in turn is converted into a digital value by the A/D conversion unit 105 for use in the control unit 104.

Next in step S230, the control unit 104 acquires time of the temperature measuring cycle and determines whether or not the temperature measuring cycle of one second has elapsed. In this embodiment, the control unit 104 includes the function of the temperature measuring cycle timer, but the temperature measuring cycle timer may be provided separately from the control unit 104.

The control unit 104 returns to step S230 if the temperature measuring cycle of one second has not elapsed, or if No in step S230.

On the other hand, if the temperature measuring cycle of one second has elapsed, that is, if Yes in step S230, the control unit 104 acquires the time counted by the energization time measuring timer and determines whether or not the standby equivalent time of 30 minutes has elapsed in step S240.

The control unit 104 returns to step S150 and executes processing of a next temperature measuring cycle if the standby equivalent time of 30 minutes has not elapsed, or if No in step S240. The processing from step S150 to step S240 correspond to one cycle of the temperature measuring cycle.

On the other hand, if the standby equivalent time of 30 minutes has elapsed, that is, if Yes in step S240, the control unit 104 ends the series of steps for temperature measurement performed by the temperature measurement system 20 on the measurement target 300.

As described above, the processing apparatus 100 according to the first embodiment measures in advance, for each installation orientation of the processing apparatus 100 and each ambient temperature of the processing apparatus 100, the temperature-induced fluctuation in the processing result by the thermocouple input unit 107 that is the analog circuit changing with the lapse of energization time of the processing apparatus 100, thereby storing the correction expressions generated on the basis of the measured values as the correction expression table.

The processing apparatus 100 then selects the appropriate correction expression from the correction expression table on the basis of the information on the installation orientation of the processing apparatus 100 and the information on the ambient temperature of the processing apparatus 100. Moreover, the processing apparatus 100 substitutes the installation orientation dir, the ambient temperature T, the energization time t, and the A/D converted value ad into the selected correction expression to calculate the correction value, and adds the calculated correction value to the A/D converted value ad, thereby correcting the A/D converted value ad.

The processing apparatus 100 can thus correct for each installation orientation dir, each ambient temperature T, and each energization time t the temperature-induced fluctuation in the processing result of the thermocouple input unit 107 that is the analog circuit changing with the lapse of the energization time of the processing apparatus 100. Therefore, the processing apparatus 100 according to the first embodiment can correct the temperature-induced fluctuation in the processing result of the thermocouple input unit 107 that is the analog circuit.

The processing apparatus 100 according to the first embodiment can thus reduce the stable operation standby time of the thermocouple input unit 107, improve the accuracy of measuring the voltage signal of the thermoelectromotive force generated by the thermocouple 200 and input to the thermocouple input unit 107, and improve the accuracy of measuring the temperature of the measurement target 300. That is, the processing apparatus 100 according to the first embodiment can measure the temperature of the measurement target 300, which is the temperature measurement target connected to the thermocouple 200, with high accuracy even before the completion of the standby equivalent time, as in the measurement of the temperature of the target 300 after the lapse of the standby equivalent time. As a result, the processing apparatus 100 can reduce the stable operation standby time of the thermocouple input unit 107, which is the analog circuit, and perform an operation that satisfies the product specifications of the processing apparatus 100 in a short time upon start-up. Note that none of the components of the processing apparatus 100 requires idle time in minutes except the thermocouple input unit 107, which is the analog circuit.

Moreover, in a case where the processing apparatus 100 is mounted on a device incorporated in an inspection apparatus or a movable part of a robot arm, the device can reduce the stable operation standby time of the thermocouple input unit 107 and perform the operation satisfying the product specifications in a short time upon start-up even when the temperature distribution inside the device is changed due to a change in the installation orientation or the installation angle of the device during energization. Note that although, in the above description, power is supplied from the external power supply 500 to the power supply unit 400, it is also possible to configure a portable thermocouple thermometer in which the processing apparatus 100 is equipped with a battery, from which power is supplied to the power supply unit 400.

### Second Embodiment

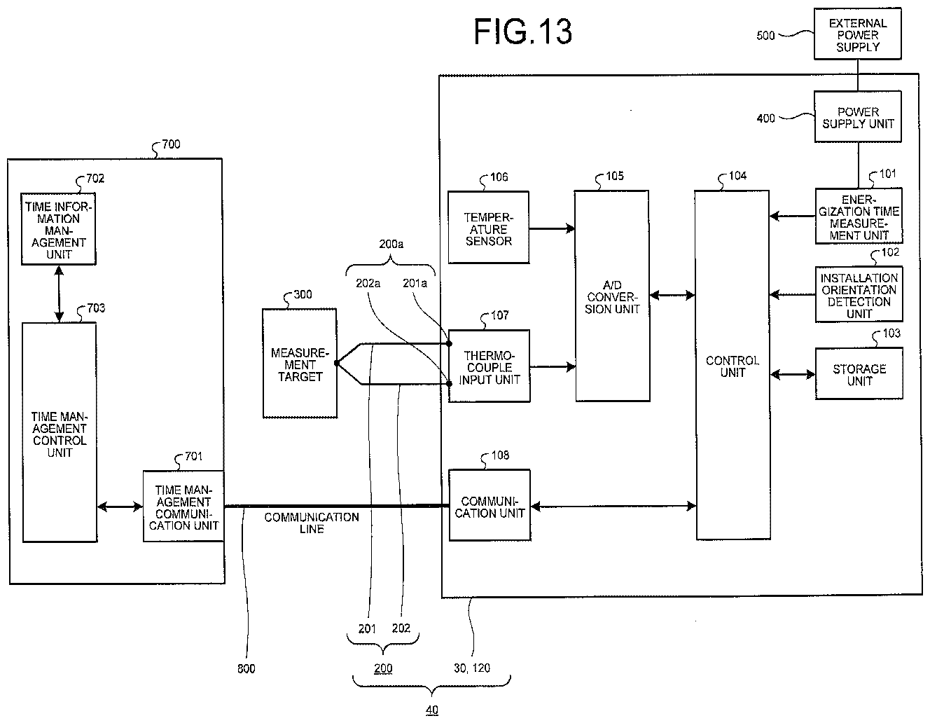

A second embodiment describes correction to an error in a measured temperature value of the measurement target 300 detected by the thermocouple input unit 107 when the power supply of a wireless device is interrupted before or after the lapse of the standby equivalent time and turned on shortly thereafter. FIG. 13 is a diagram illustrating the configuration of a temperature measurement system 40 including a processing apparatus 120 according to the second embodiment of the present invention. The processing apparatus 120 according to the second embodiment is different from the processing apparatus 100 according to the first embodiment in that the processing apparatus 120 includes a communication unit 108 that communicates with a time management device 700. Thus, the processing apparatus 120 according to the second embodiment basically has the same configuration and functions as the configuration and functions of the processing apparatus 100 according to the first embodiment. The processing apparatus 120 and the thermocouple 200 define the temperature measurement system 40 according to the second embodiment. Note that the processing apparatus 120 can be configured as a wireless device 30 which is a remote unit including a wireless communication function. The wireless device 30 includes a plurality of circuits implementing the wireless communication function, but the description thereof will be omitted. Thus, in this case, the wireless device 30 and the processing apparatus 120 can be thought of as being functionally identical.

The time management device 700 manages reference time information which is information on a reference time which the processing apparatus 120 uses as the current time. The time management device 700 includes a time management communication unit 701, a time information management unit 702, and a time management control unit 703. The time management communication unit 701 communicates with the processing apparatus 120. The time information management unit 702 manages the reference time information that is the information on the reference time which the processing apparatus 120 uses as the reference current time. The time management control unit 703 controls the time management communication unit 701 and the time information management unit 702.

The communication unit 108 of the processing apparatus 120 is connected to the time management communication unit 701 of the time management device 700 via a communication line 800, and communicates with the time management communication unit 701 via the communication line 800. The time management communication unit 701 and the communication unit 108 may employ any mode of communication therebetween as long as the time management communication unit 701 of the time management device 700 can transmit time information to the communication unit 108 of the processing apparatus 120. The communication line 800 is unnecessary when the communication units perform wireless communication.

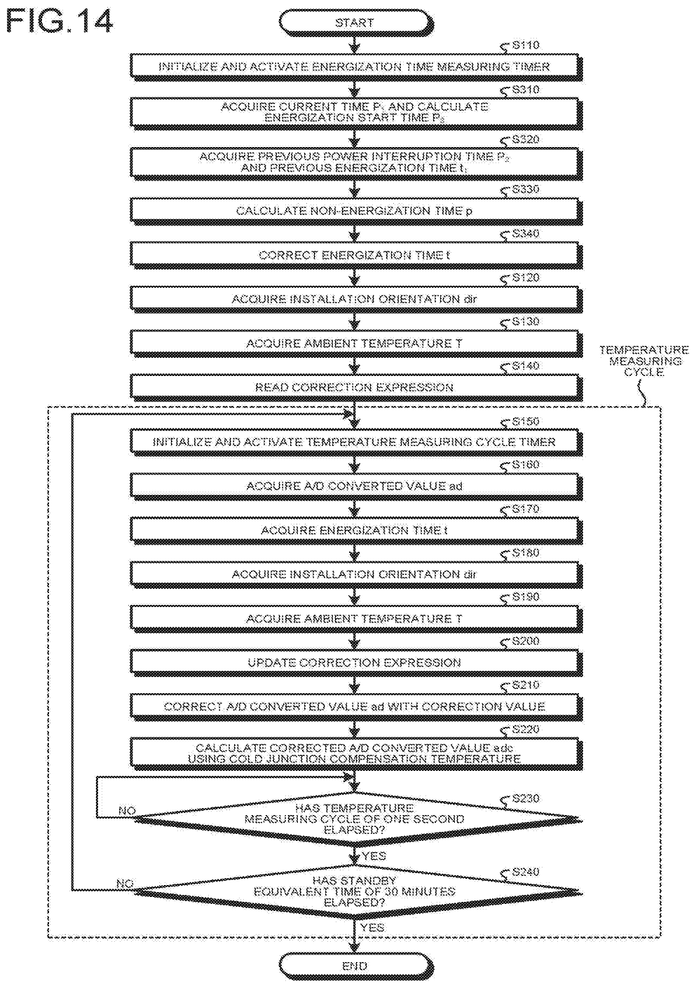

FIG. 14 is a flowchart describing a procedure of a method of measuring the temperature of the measurement target 300 by the processing apparatus 120 according to the second embodiment of the present invention. The flowchart in FIG. 14 illustrates the procedure of calculating the temperature of the measurement target 300 by correcting an error in the measured temperature value of the measurement target 300 detected by the thermocouple input unit 107 when the temperature of the measurement target 300 is measured before the standby equivalent time of the processing apparatus 120 elapses. The procedure illustrated in FIG. 14 is based on the assumption that the supply of power to the processing apparatus 120 is restored in a short time, that is, that the power supply of the processing apparatus 120 is turned on shortly after the power supply is turned off. Note that in the flowchart illustrated in FIG. 14, a step identical to the step of the flowchart illustrated in FIG. 3 is assigned the same step number as the step number assigned to such step in FIG. 3.

To correct the error in the measured temperature value of the measurement target 300 detected by the thermocouple input unit 107, the processing apparatus 120 acquires information including the installation orientation dir of the processing apparatus 120, the ambient temperature T of the processing apparatus 100 120, the energization time t for the processing apparatus 120, the A/D converted value ad, a current time P1, a previous power interruption time P2, and a previous energization time t1. In other words, the control unit 104 of the processing apparatus 120 acquires the current time P1, the previous power interruption time P2, and the previous energization time t1 in addition to the information acquired by the control unit 104 of the processing apparatus 100 in the first embodiment. The previous power interruption time P2 is the time when the power supply of the processing apparatus 120 is interrupted the last time. The previous energization time t1 is the last energization time of the processing apparatus 120 from when the power supply of the processing apparatus 120 is turned on to when the power supply is turned off.

First in step S110, as in step S110 of the flowchart illustrated in FIG. 3, the control unit 104 initializes the energization time measuring timer of the energization time measurement unit 101 to set a count value to zero, and activates the energization time measuring timer to start measuring the energization time of the processing apparatus 120. The following description is based on the assumption that the energization time measuring timer updates the time in increments of the minute and the standby equivalent time of the processing apparatus 120 is set to 30 minutes.

In step S310, the control unit 104 starts communicating with the time management device 700 and acquires the current time P₁, which is the current time information, from the time information management unit 702 of the time management device 700 via the time management control unit 703, the time management communication unit 701, the communication line 800, and the communication unit 108. The control unit 104 further reads and acquires the energization time t from the energization time measurement unit 101. The control unit 104 then calculates an energization start time P₃ by subtracting the energization time t from the acquired current time P₁. In the same step, meanwhile, the time management control unit 703 in the time management device 700 reads the current time P₁, which is the current time information, from the time information management unit 702 at the start of the communication with the processing apparatus 120 or immediately after the start of the communication, and transmits the current time P₁ to the control unit 104 of the processing apparatus 120 via the time management communication unit 701.

Next in step S320, the control unit 104 reads and acquires the previous power interruption time P₂ and the previous energization time t₁ from the storage unit 103. The control unit 104 stores the previous power interruption time P₂ and the previous energization time t₁ in the storage unit 103 when the power supply of the processing apparatus 120 is turned off the last time. The control unit 104 thus has a function as a previous energization time acquiring unit that acquires the previous energization time t₁. Note that the previous energization time acquiring unit may be provided separately from the control unit 104.

In step S330, the control unit 104 calculates a non-energization time p from the previous power interruption time P₂ to the energization start time P₃ by subtracting the previous power interruption time P₂ from the energization start time P₃. That is, the control unit 104 has a function as a non-energization time acquiring unit that acquires the non-energization time p. Note that the non-energization time acquiring unit may be provided separately from the control unit 104.

In step S340, the control unit 104 corrects the energization time t. When the non-energization time p is shorter than the standby equivalent time of 30 minutes, the control unit 104 calculates an energization time correction value by substituting the non-energization time p and the previous energization time t₁ into a correction expression t [p] [t₁], and corrects the energization time t by adding the energization time correction value to the energization time t. The energization time correction value, which is a correction value defined based on the non-energization time p and the previous energization time t₁, is used in correcting the error in the measured temperature value of the measurement target 300 acquired by the thermocouple 200.

The correction value expression t [p] [t1] is prepared on the basis of measured values acquired in advance by measuring the relationship between the error of the thermocouple input unit 107 and the times p, t1 (the non-energization time p and the previous energization time t1) and, and is stored in the storage unit 103. In the correction expression t [p] [t1], “[p]” represents the non-energization time p, and “[t1]” represents the previous energization time t1. The control unit 104 calculates the energization time correction value by substituting the non-energization time p and the previous energization time t1 into the correction value expression t [p] [t1], and adds the energization time correction value to the energization time t. It is to be noted that the energization time t need not be corrected when the non-energization time p is longer than or equal to the standby equivalent time of 30 minutes.

When the power supply of the processing apparatus 120 is interrupted before or after the lapse of the standby equivalent time and is turned on in a short time thereafter, the standby equivalent time required after the restoration of the power supply is reduced due to residual heat by the previous driving, whereby the processing illustrated in the first embodiment may fail to properly correct the error in the measured temperature value of the measurement target 300 detected by the thermocouple input unit 107. Thus, when there is a possibility that the power supply of the processing apparatus 120 is turned on shortly after being interrupted, the control unit 104 acquires the current time information by communicating with the time management device 700 that manages the reference time information used as the current time by the processing apparatus 120. On the basis of the energization time and the non-energization time before the previous power interruption, then, the control unit 104 corrects the energization time to be substituted into the correction expression AD [dir] [T] [t] [ad]. As a result, the error in the measured temperature value of the measurement target 300 detected by the thermocouple input unit 107 can be corrected taking into consideration the influence of the residual heat due to the previous driving of the processing apparatus 120.

Step S120 and the subsequent steps are the same as step S120 and the subsequent steps of the flowchart illustrated in FIG. 3. In this case, the energization time t corrected in step S340 is used in step S210. Note that the control unit 104 monitors a state of power supply to the processing apparatus 120 or a specific functional unit in the processing apparatus 120 in order to detect the interruption of power supply of the processing apparatus 120 in the energization time measurement unit 101, and the control unit 104 executes processing that stores the current time P₁ and the energization time t in the storage unit 103 when detecting the interruption of power supply to the specific functional unit. The state of power supply to the specific function unit may be monitored by a dedicated power supply monitoring functional unit other than the control unit 104.

In this case, the dedicated power supply monitoring functional unit and the control unit 104 are configured to be powered off last in the processing apparatus 120. The control unit 104 sets, as a high priority interrupt condition, monitoring of the power supply state to the specific functional unit or reception of a power supply interruption detection signal from the power supply monitoring functional unit indicating detection of the interruption of power supply to the specific functional unit. With such a high priority interrupt condition set, the control unit 104 periodically checks the monitoring of the power supply state to the specific functional unit or the power supply interruption detection signal before execution of each step in the flowchart illustrated in FIG. 14. As a result, the control unit 104 can detect the interruption of the power supply to the processing apparatus 120 and execute the processing that stores the current time and energization time in the storage unit 103.

As described above, the processing apparatus 120 according to the second embodiment has the same effect as that provided by the processing apparatus 100 according to the first embodiment. Moreover, when the power supply of the processing apparatus 120 is interrupted before or after the lapse of the standby equivalent time and is turned on in a short time thereafter, the processing apparatus 120 can correct the temperature-induced error of the thermocouple input unit 107 in the measured temperature value of the measurement target 300 detected by the thermocouple input unit 107, taking into consideration the influence of the residual heat by the previous driving of the processing apparatus 120. Therefore, the processing apparatus according to the second embodiment can correct the temperature-induced fluctuation in the processing result of the thermocouple input unit 107 that is the analog circuit, even when the power supply of the processing apparatus 120 is turned off and on in a short time.

Thus, as with the processing apparatus 100 according to the first embodiment, the processing apparatus 120 according to the second embodiment can reduce the stable operation standby time of the thermocouple input unit 107, improve the accuracy of measuring the voltage signal of the thermoelectromotive force generated by the thermocouple 200 and input to the thermocouple input unit 107, and improve the accuracy of measuring the temperature of the measurement target 300 even when the power supply of the processing apparatus 120 is turned off and on in a short time. That is, the processing apparatus 120 according to the second embodiment can measure the temperature of the measurement target 300, which is the temperature measurement target connected to the thermocouple 200, with high accuracy as in the measurement of the temperature of the target 300 after the lapse of the standby equivalent time before the lapse of the standby equivalent time, even when the power supply of the processing apparatus 120 is turned off and on in a short time. As a result, the processing apparatus 120 can reduce the stable operation standby time of the thermocouple input unit 107 that is the analog circuit and perform an operation that satisfies the product specifications of the processing apparatus 120 in a short time upon start-up. Note that none of the components of the processing apparatus 120 requires idle time in minutes except the thermocouple input unit 107, which is the analog circuit.

The configuration illustrated in the above embodiments merely illustrates an example of the content of the present invention, and can thus be combined with another known technique or partially omitted and/or modified without departing from the scope of the present invention.

### REFERENCE SIGNS LIST

10, 30 wireless device; 20, 40 temperature measurement system; 100, 120 processing apparatus; 100a reference position; 100b upper surface; 101 energization time measurement unit; 102 installation orientation detection unit; 103 storage unit; 104 control unit; 105 analog-to-digital conversion unit; 106 temperature sensor; 107 thermocouple input unit; 108 communication unit; 200 thermocouple; 200a terminal; 201, 202 metal wire; 201a, 202a terminal; 300 measurement target; 400 power supply unit; 500 external power supply; 601 processor; 602 memory; 700 time management device; 701 time management communication unit; 702 time information management unit; 703 time management control unit; 800 communication line; p non-energization time; P₁ current time; P₂ previous power interruption time; P₃ energization start time; t energization time; t₁ previous energization time.

1: A processing apparatus having an analog circuit therein, the processing apparatus comprising:
an installation orientation detector to detect a position of installation of the processing apparatus;
an energization time measurement timer to measure an energization time during which the processing apparatus is energized;
a processor to execute a program; and
a memory to store the program which, when executed by the processor, performs a process of correcting a result of processing in the analog circuit on the basis of a result of detection by the installation orientation detector and a result of measurement by the energization time measurement timer.

2: The processing apparatus according to claim 1, when the program is executed by the processor, the program further performs processes of:
acquiring a non-energization time of the processing apparatus from a previous power interruption time at which a power supply of the processing apparatus is turned off last time, to an energization start time at which the power supply of the processing apparatus is turned on this time; and
acquiring a previous energization time that is an energization time of the processing apparatus from a time at which the power supply of the processing apparatus is tuned on last time to a time at which the power supply of the processing apparatus is turned off last time, wherein
the result of processing in the analog circuit is corrected on the basis of the non-energization time and the previous energization time.

3: The processing apparatus according to claim 1, wherein the memory further stores a correction expression for calculating a correction value that corrects the result of processing in the analog circuit on the basis of the result of detection by the installation orientation detector and the result of measurement by the energization time measurement timer.

4: The processing apparatus according to claim 1, wherein the analog circuit is connected to a thermocouple for receiving input of a voltage signal of a thermoelectromotive force generated by the thermocouple.

5: The processing apparatus according to claim 2, wherein the memory further stores a correction expression for calculating a correction value that corrects the result of processing in the analog circuit on the basis of the result of detection by the installation orientation detector and the result of measurement by the energization time measurement timer.

6: The processing apparatus according to claim 2, wherein the analog circuit is connected to a thermocouple for receiving input of a voltage signal of a thermoelectromotive force generated by the thermocouple.

7: The processing apparatus according to claim 3, wherein the analog circuit is connected to a thermocouple for receiving input of a voltage signal of a thermoelectromotive force generated by the thermocouple.

8: The processing apparatus according to claim 5, wherein the analog circuit is connected to a thermocouple for receiving input of a voltage signal of a thermoelectromotive force generated by the thermocouple.
